(19) United States
(12) Patent Application Publication
(10) Pub. No.: US 2026/0368801 A1
(43) Pub. Date: Nov. 19, 2026

(54) Order Recognition Intelligence For Order Verification

(71) Applicant: CSS Solutions LLC, Los Angeles, CA (US)

(72) Inventors: Ori Gilad, Los Angeles, CA (US); Joao Pedro Barbosa Nogueira, Glendale, CA (US)

(73) Assignee: CSS Solutions LLC, Los Angeles, CA (US)

(21) Appl. No.: 19/679,142

(22) Filed: May 15, 2026

Related U.S. Application Data
(60) Provisional application No. 63/806,869, filed on May 16, 2025.

(51) Int. Cl. G06Q 30/0601; G06Q 20/20

(52) U.S. Cl. CPC G06Q 30/0637; G06Q 20/209; G06Q 30/0643

(57) ABSTRACT

Aspects of the disclosure are directed to food order verification using a machine learning model. The machine learning model may be trained using data with varying food items, food packaging, various camera angles, resolution, etc. The system may be configured to identify individual food items captured by an image-capturing device in real time and compare each item of the captured image against the food items listed in the order receipt. The system may be configured to map each food item to the order receipt and notify users of any inconsistencies between the food items expected from the order receipt and the identified food items.

### CROSS-REFERENCE TO RELATED APPLICATIONS

This application claims the benefit of the filing date of United States Provisional Patent Application No. 63/806,869 filed May 16, 2025, the disclosure of which is hereby incorporated herein by reference.

### BACKGROUND

Order disputes between restaurants and online food ordering (OFO) platforms commonly arise when customers receive incorrect or incomplete food deliveries. When such disputes occur, the customers may report the incorrect or incomplete order and request refunds. These order disputes can result in significant revenue losses for both restaurant and OFO platforms, not only due to issuing the refunds, but also from the time, labor, and operational costs associated with handling such order disputes. To mitigate the revenue losses, many OFO platforms provide revenue recapture programs that allow restaurants to reclaim part of the lost revenue. However, it remains challenging to determine whether the incorrect or incomplete food preparation occurred and, even if it occurred, it is difficult to determine at what stage of the preparation process such errors occurred. Typically, order disputes are only discovered at the end stage when a customer opens the delivered food package.

To address these issues, many OFO platforms have recently made stricter guidelines to validate order disputes by requiring verified photographic proof from the restaurants and/or the customers. If a customer files a complaint about incorrect or incomplete food deliveries and requests a refund, the OFO platforms may now demand visual evidence from both parties. Although this may help to lower the dispute occurrences, it may lead to an increase in operational burden on the restaurant, requiring additional time, labor, and resources to discern the visual evidence. Some other OFO platforms have chosen more proactive solutions. For example, some fast-food restaurants have implemented weighing scales to verify order accuracy by weight, while other restaurants have introduced manually triggered cameras to record the packaging process. A few restaurants have experimented with surveillance cameras.

However, all the above solutions have limitations. Relying on visual evidence, such as photos of food being prepared or a package, may not provide conclusive proof under certain circumstances since different OFO platforms might adopt varying levels of image resolution, timestamp accuracy, camera angles. etc.

### BRIEF SUMMARY

Aspects of the disclosure are directed to a food order verification system (hereinafter referred to as “system”) based on a real-time comparison of captured images of the food items being prepared and an order receipt using a machine learning model. The system may be configured to prevent order disputes in real-time by directly reading and analyzing the order receipt without human intervention. The system may also be configured to generate and store visual evidence for potential order disputes or evidence of a lack of visual evidence for use in further investigation. The system may be automatically updated and reconfigured for varying restaurants or food items. The system may include an image-capturing device automatically configured for targeted OFO platforms and/or specific customers.

An aspect of the disclosure provides for a method for verifying an order status. The method may comprise receiving, by one or more processors, an order receipt; capturing, by an image capturing device, an image of the received order receipt; capturing, by the image capturing device, one or more food items placed within a field of view of the image capturing device; determining, by the one or more processors, whether any food items indicated in the order receipt are missing; and automatically generating, by the one or more processors, a coded notification for display on a user interface in response to determining that one or more food items are missing from the field of view of the image capturing device, wherein the coded notification is generated, by the one or more processors using various colors, codes, or symbols in real-time.

In some examples, the method may further comprise taking a snapshot or recording a video file using the image-capturing device.

In some examples, the method may further comprise utilizing a machine learning model to generate the coded notification.

In some examples, the method may further comprise utilizing a machine learning model to determine whether any food items are missing.

In some examples, the generated coded notification may be dynamically updated in real time as one of the missing food items is provided within the field of view of the image capturing device.

In some examples, the method may further comprise generating a final notification indicating a completion of the food items indicated in the order receipt.

In some examples, the method may further comprise capturing a final image of the food items after the final notification is generated and transmitting the final image of the food items to a delivery party and a customer.

Another aspect of the disclosure provides for a system for verifying an order status. The system may comprise one or more processors; and one or more storage devices coupled to the one or more processors and storing instructions that, when executed by the one or more processors, cause the one or more processors to: receive an order receipt; capture an image of the received order receipt using an image-capturing device; capture, using the image capturing device, one or more food items placed within a field of view of the image capturing device; determine whether any food items indicated in the order receipt are missing; and automatically generate a coded notification for display on a user interface in response to determining that one or more food items are missing from the field of view of the image capturing device, wherein the coded notification is generated using various colors, codes, or symbols in real-time.

In some examples, the one or more processors may be configured to take a snapshot or record a video file using the image-capturing device.

In some examples, the one or more processors may be configured to utilize a machine learning model to generate the coded notification.

In some examples, the one or more processors may be configured to utilize a machine learning model to determine whether any food items are missing.

In some examples, the generated coded notification may be dynamically updated in real time as one of the missing food items is provided within the field of view of the image capturing device.

In some examples, the one or more processors may be configured to generate a final notification indicating a completion of the food items indicated in the order receipt.

In some examples, the one or more processors may be configured to capture a final image of the food items after the final notification is generated and transmit the final image of the food items to a delivery party and a customer.

Yet another aspect of the disclosure provides for a non-transitory computer-readable medium for storing instructions that, when executed by one or more processors, cause the one or more processors to perform the method comprising: receiving an order receipt; capturing an image of the received order receipt using an image-capturing device; capturing one or more food items placed within a field of view of the image-capturing device; determining whether any food items indicated in the order receipt are missing; and automatically generating a coded notification for display on a user interface in response to determining that one or more food items are missing from the field of view of the image-capturing device, wherein the coded notification is generated using various colors, codes, or symbols in real-time.

In some examples, the method may further comprise taking a snapshot or recording a video file using the image-capturing device.

In some examples, the method may further comprise utilizing a machine learning model to generate the coded notification.

In some examples, the method may further comprise utilizing a machine learning model to determine whether any food items are missing.

In some examples, the method may further comprise generating a final notification indicating a completion of the food items indicated in the order receipt.

In some examples, the method may further comprise capturing a final image of the food items after the final notification is generated and transmitting the final image of the food items to a delivery party and a customer.

### BRIEF DESCRIPTION OF THE DRAWINGS

FIG. 1 depicts a block diagram of an example order verification system according to aspects of the disclosure.

FIG. 2 depicts a block diagram of an example environment for implementing an order verification system according to aspects of the disclosure.

FIG. 3 depicts a block diagram illustrating one or more machine learning model architectures according to aspects of the disclosure.

FIG. 4 depicts a block diagram illustrating example camera and display screen mounted on a food bagging tray according to aspects of the disclosure.

FIG. 5A-5D depicts a diagram illustrating an example display screen according to aspects of the disclosure.

FIG. 6 depicts a flow diagram of an example process for order verification according to aspects of the disclosure.

FIG. 7 depicts a flow diagram of an example order receipt ingesting process according to aspects of the disclosure.

FIG. 8 depicts a flow diagram of an example order receipt analysis process according to aspects of the disclosure.

FIG. 9 depicts a flow diagram of an example image capturing process according to aspects of the disclosure.

FIG. 10 depicts a flow diagram of an example process for updating order verification according to aspects of the disclosure.

### DETAILED DESCRIPTION

The present approach generally relates to food order verification using a machine learning model. The machine learning model may be trained using data with varying food items, food packaging, various camera angles, resolution, etc. The system may be configured to identify individual food items captured by an image-capturing device in real time and compare each item of the captured image against the food items listed in the order receipt. An “order receipt” can be any receipt, kitchen ticket, station ticket, or any printed ticket or slip containing order information or an order ID, as well as any digital or electronic representation of order information received directly via a POS system, API, network integration, or other such data transaction system. The system may be configured to map each food item to the order receipt and notify users of any inconsistencies between the food items expected from the order receipt and the identified food items. Order information may be ingested by the system via reading the ticket/receipt directly. Order information may also be ingested by the system via direct integrations with POS systems, APIs, or other order manager systems. Order information may be ingested over external networks or internal networks. Order information may be ingested in a combination of these mechanisms.

The system may be configured to send snapshots of order correctness to the servers or a remote database. The sent snapshots may be used as training data. The camera may be housed within or mounted on or in the vicinity of the bagging station and configured to run automatically and restart in case of failures. The system may be configured to be trained using input and target data for real-time evaluation. The system may provide a user-friendly graphical user interface to show photos and checklists. Based on the training, the user may be instructed to adjust camera calibration for better resolution or better quality of captured images, or to adjust the camera’s position such that the camera captures images from angles tailored to capture specific information readable from the food packages. The hardware and lens of the camera may be protected from heat and grease in the kitchen area. Such protection may include barriers, containers, heat resistant materials, moisture block materials, or other combinations of such. For instance, the camera may be positioned behind a barrier comprising a heat and/or moisture resistant material. In one example, the camera may be positioned behind or within a plastic barrier.

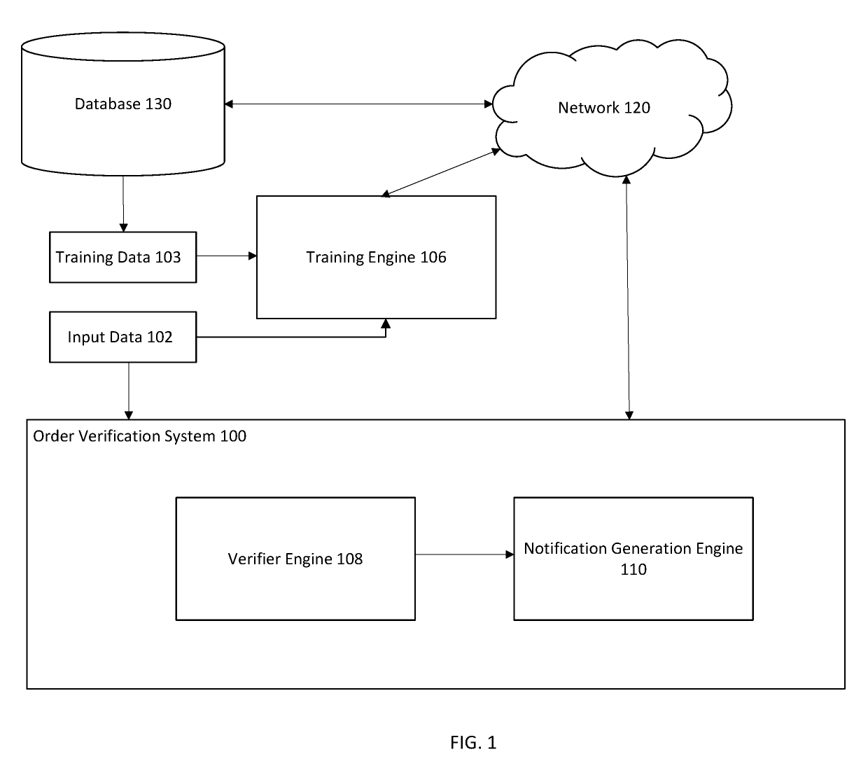

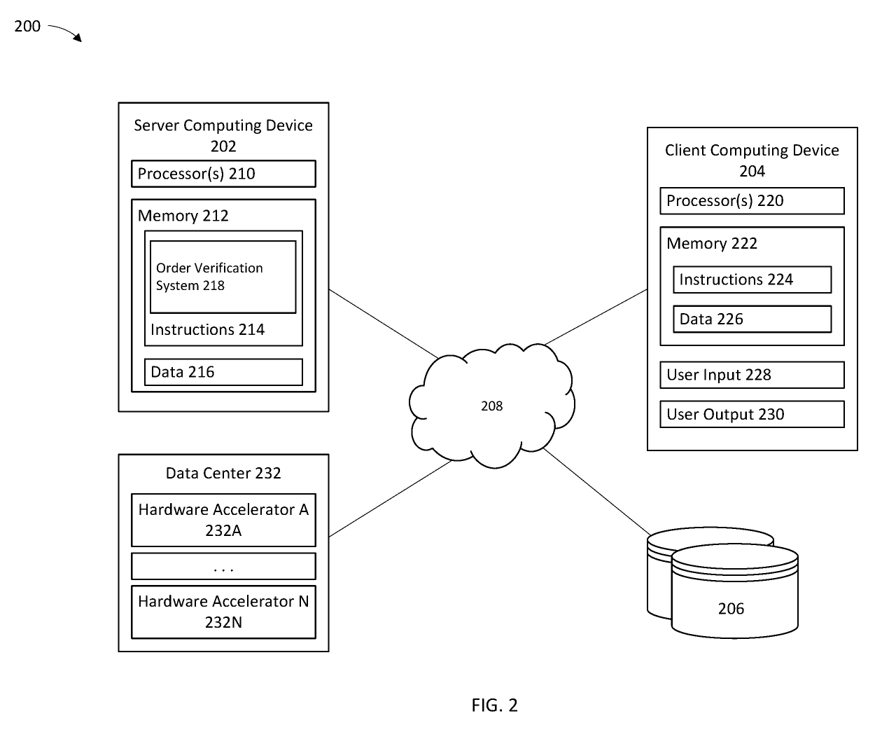

FIG. 1 depicts a block diagram of an example order verification system 100. Order verification system 100 may be implemented on one or more computing devices, such as client computing device 204 as depicted in FIG. 2. Order verification system 100 may be configured to receive input data 102 for use in verifying whether the ordered food items are being correctly prepared or missing any items in real time. Order verification system 100 may receive input data 102 as part of a call to an API exposing order verification system 100 to one or more computing devices. Input data 102 may be provided to order verification system 100 through a non-transitory storage medium, including remote storage connected to one or more computing devices over a network. Input data 102 may also be provided as input through a user interface on a client computing device coupled to order verification system 100.

Input data 102 may include data associated with particular food containers, boxes, cups, wrappers (each of which may, individually or collectively, be referred to herein as “containers”), and readable text or image or logo information from the containers, etc. Input data 102 may include images of food items within a container. The food items may include any type of food that can be wrapped and packaged into one or more bags for food delivery services. Input data 102 may also include any photographs or video capture and or recorded by one or more cameras or any other visual recording devices or image capturing devices. In some instances, input data may also include data read by sensors such as barcode readers, RFID tags, etc. Input data 102 may, in some instances, include any detailed information about specific food items, ingredients, special items such as seasonal or temporary menu items, specific flavors, any variations in recipes, etc.

Training Engine 106 may be implemented on one or more server computing devices such as server computing device 202 as depicted in FIG. 2. Training engine 106 may receive training data 103 from database 130 for training one or more machine learning models for food order verification. . Training engine 106 may also be configured to use input data 102 for training purposes. Training data 103 may correspond to a machine learning task for assisting in generating notifications to a user, such as a task performed by a neural network to determine which food item is missing or incorrectly prepared. The machine learning task may also include verification and generating notifications based on the historical data of the food orders and/or other restaurants engaged in similar food types, and/or food delivery services. According to some examples, training engine 106 may be implemented on one or more client computing devices together with order verification system 100. In other examples, machine learning models for performing the order verification may be trained and executed remotely, such as in the cloud.

Training data 103 can be in any form suitable for training a machine learning model (hereinafter referred to as “model”), according to one of a variety of different learning techniques. Learning techniques for training a model can include supervised learning, unsupervised learning, and/or semi-supervised learning techniques. For example, training data 103 can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

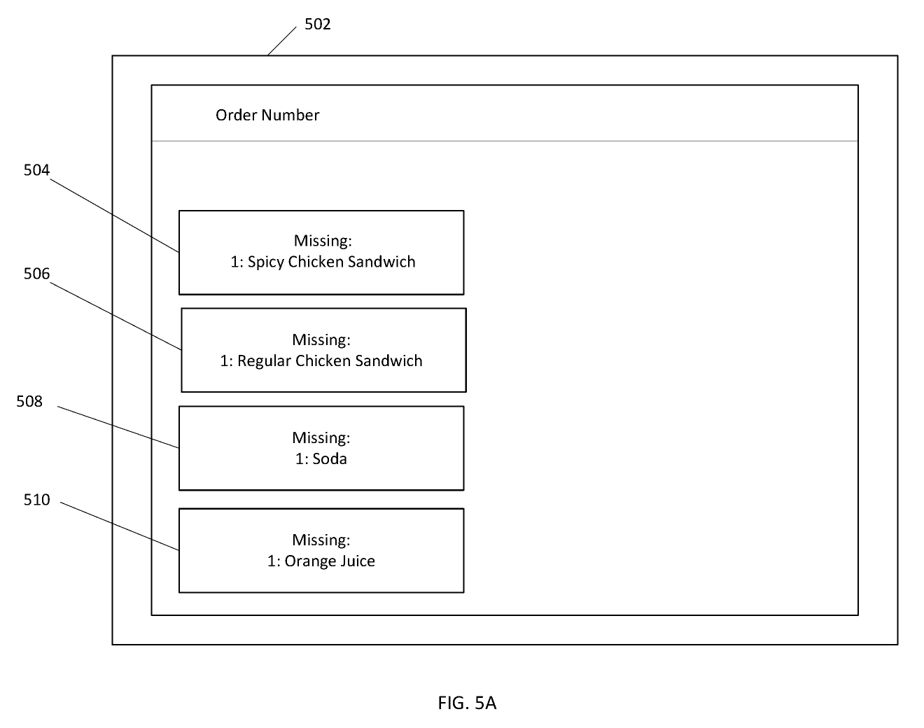

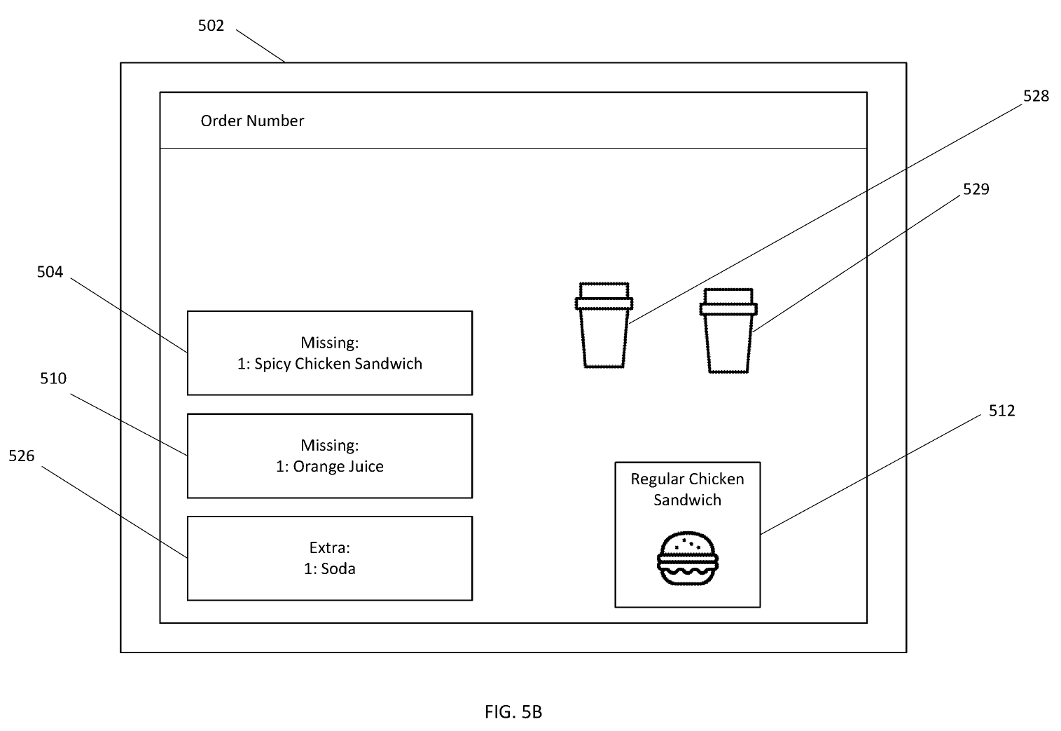

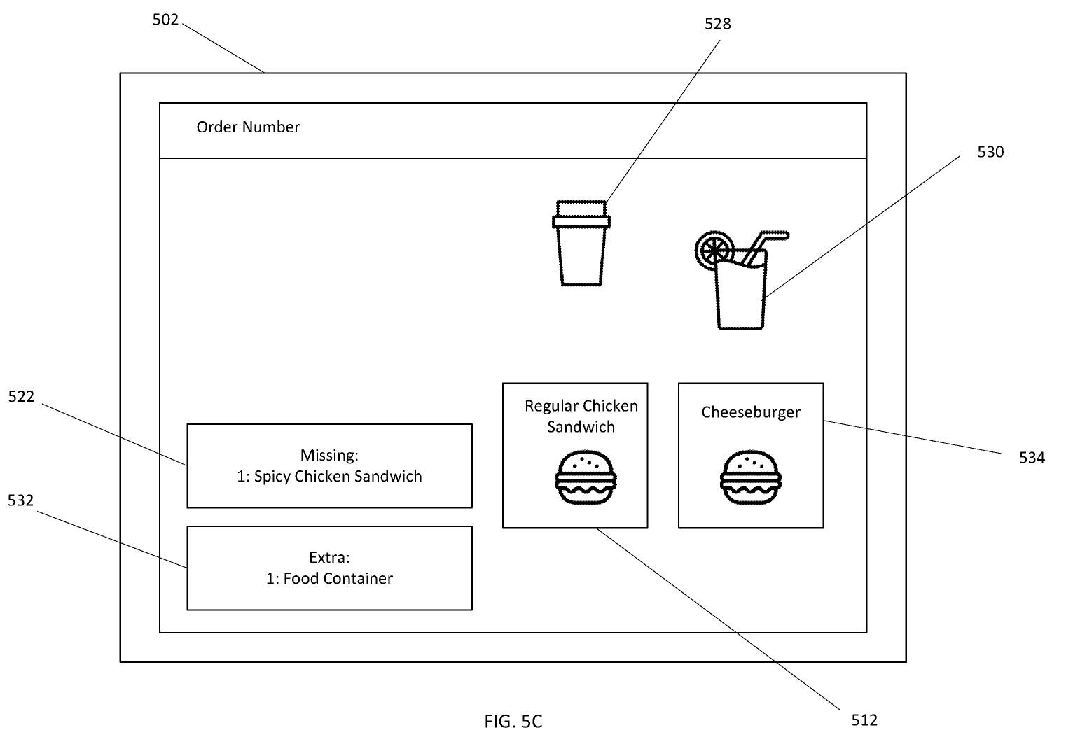

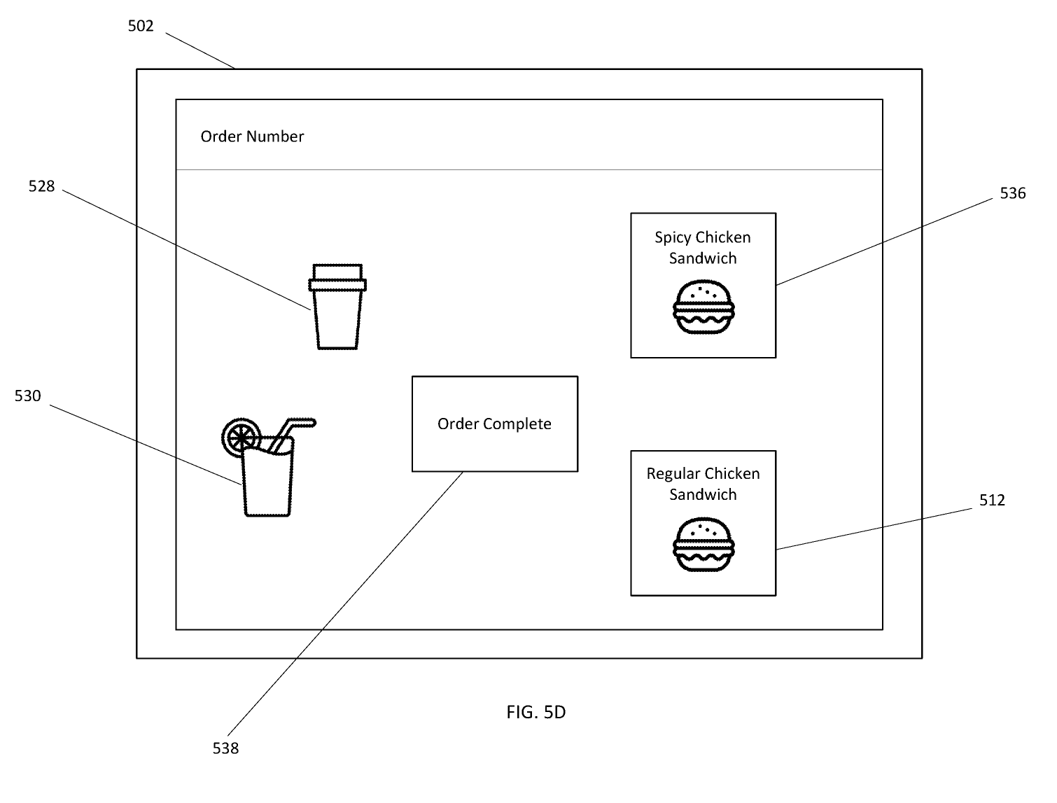

Order verification system 100 may be configured to output one or more specific notifications when certain food items are missing or incorrectly prepared. If a food item cannot be detected or identified using a camera system, order verification system 100 may generate a notification indicating that a particular food item is missing. The camera system may be mounted to a bagging station in a kitchen area and configured to continually monitor the food items as they are being prepared and placed on the bagging tray by restaurant employees. If an extra food item is placed on a bagging tray, order verification system 100 may generate a notification indicating that a food item that has not been ordered is placed on the bagging tray. Order verification system 100 may use machine learning models trained to identify and discern similar but different food items wrapped in similar containers or wrappers. For example, as described in more detail in connection with FIGS. 5A-D below, order verification system 100 may be configured to discern whether a regular chicken sandwich is wrapped in a container or a spicy chicken sandwich is wrapped in a similar container. The two kinds of chicken sandwich may be wrapped in the almost identical wrapper, but order verification system 100 may utilize machine learning models particularly trained for distinguishing the two similar food items based on, for example, a small marking or sticker affixed to each wrapper, a subtle difference in the sizes of the wrapper, or any other slight visual difference that is challenging to restaurant employees to immediately notice. When the restaurant employee receives the notification on the display screen, the restaurant employee may correct the food order by replacing the incorrect food items with the correct food items or adding the missing food items. As the restaurant employee corrects the food items placed on the bagging tray, the camera system continually monitors and updates the notification on the display in real time. Once the correct food items are identified by order verification system 100, the complete notification is displayed on the display screen.

Order verification system 100 may store the captured image of the food items and order receipts, and information related to the notifications generated for preparing the food items for each order receipt in database 130 via network 120. Any information related to trials and errors recorded and/or notified to the restaurant employee while preparing the food items may be stored in the remote database and used as training data 103.

The captured images of the prepared food items may also be stored and formatted in a particular format suitable for submission to OFO platforms to respond to a potential customer complaint and initiation of an order dispute process. When the OFO platforms notify the responsible restaurant of any filed complaint, the order verification system 100 may be configured to automatically receive, review, and analyze the complaint. Verification system 100 may be configured to identify the corresponding order numbers and retrieve corresponding captured images or recorded video from database 130 via network 120. Verification system 100 may be configured to automatically submit the retrieved captured images or recorded video to the OFO platform in response to the filed complaint. According to some examples, verification system 100 may also be configured to capture images or video of the food items as they are placed into a delivery package, such as a bag or a box. This allows verification system 100 to store records confirming that the prepared food items were indeed packed for delivery.

Order verification system 100 may include verifier engine 108. Verifier engine 108 may be implemented as one or more computer programs, specially configured electronic circuitry, or any combination thereof. Verifier engine 108 may be configured to verify whether the order for food items contained in the order receipts is being correctly prepared by restaurant employees. The order receipts can be ingested and analyzed using the camera system(s) mounted on the bagging tray. Verifier engine 108 may receive input data 102. Input data 102 may include visual images of any food items placed on the bagging tray captured using the camera systems. Verifier engine 108 may be configured to communicate with databases of the historical data of past orders and errors recorded in the past. Verifier engine 108 may be configured to monitor each item on the bagging tray as each item is placed on the bagging tray. Verifier engine 108 may be configured to verify each food item against each item in the list contained in the received order receipt.

Order verification system 100 may include notification generation engine 110. Notification generation engine 110 may be configured to receive the verification result as each food item is placed on the bagging tray and generate a notification for display on a display screen. Notification generation engine 110 may be configured to generate various notifications. The notifications may include notifications for missing or incorrect food items, or notifications showing whether the order is ready to be delivered. Notification generation engine 110 may be configured to directly communicate with the computer system of OFO platforms (not shown), notifying the OFO platform that the ordered food items are ready for delivery.

Each notification may be dynamically coded in different colors, shapes, and/or symbols, and/or be generated for display in a variety of formats. For example, when an additional food item is placed on the bagging tray, a notification may be displayed in blue color, while if there is a missing food item, a notification may be generated and displayed in red. Icons or symbols may also be used to notify a user of a particular missing food item. For example, icons or symbols may include any symbols representing organic juice, a chicken sandwich, a particular soda, etc. It is understood that the above notification may be generated using sound or haptic effects using known techniques.

FIG. 2 depicts a block diagram of an example environment 200 for implementing an order verification system. The order verification system may be implemented in a server computing device 202 having one or more processors in one or more locations. The server computing device 202 can be communicatively coupled to a client computing device 204 as well as one or more storage devices 206 over a network 208.

The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The devices 202, 204 may be capable of direct and indirect communication over the network 208. For example, using a network socket, the client computing device 204 can connect to a service through an Internet protocol. The devices 202, 204 can set up listening sockets that may accept an initiating connection for sending and receiving information. The network 208 itself may include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between devices 202, 204, including over various types of Ethernet connection. It will be understood that operation of the system may occur “offline,” such that no connection to the internet is necessary for operation of the system. In this regard, the devices 202, 204, 206, and 232 may be configured to perform all necessary processing without requiring an internet connection and/or over a local network. In some instances, device 202, 204, 206 may be configured to perform the processing of data center 232.

Although a single server computing device 202 and client computing device 204 are shown in FIG. 2, it is understood that aspects of the disclosure can be implemented according to a variety of different configurations and quantities of computing devices, including in paradigms for sequential or parallel processing, or over a distributed network of multiple devices.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of non-transitory computer-readable medium capable of storing information accessible by processors 210, such as volatile and non-volatile memory. The processors 210 can include one or more central processing units (CPUs), graphic processing units (GPUs), field-programmable gate arrays (FPGAs), and/or application-specific integrated circuits (ASICs).

The instructions 214 can include one or more instructions that, when executed by the processors 210, cause the one or more processors to perform actions defined by the instructions 214. The instructions 214 can be stored in object code format for direct processing by the processors 210, or in other formats, including interpretable scripts or collections of independent source code modules that are interpreted on demand or compiled in advance. The instructions 214 can include instructions for implementing order verification system 218, which may correspond to order verification system 100 of FIG. 1. Order verification system 218 can be executed using processors 210, and/or using other processors remotely located from the server computing device 202.

Data 216 can be retrieved, stored, or modified by processors 210 in accordance with the instructions 214. Data 216 can be stored in computer registers, in a relational or non-relational database as a table having a plurality of different fields and records, or as JSON, YAML, proto, or XML documents. Data 216 can also be formatted in a computer-readable format such as, but not limited to, binary values, ASCII, or Unicode. Moreover, data 216 can include sufficient information to verify relevant credentials, such as numbers, descriptive text, proprietary codes, pointers, references to data stored in other memories, including other network locations, or information that is used by a function to calculate relevant data.

Client computing device 204 can also be configured similarly to the server computing device 202, with one or more processors 220, memory 222, instructions 224, and data 226. Client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

Server computing device 202 can be configured to transmit data to client computing device 204, and client computing device 204 can be configured to display at least a portion of the received data on a display implemented as part of user output 230. User output 230 can also be used for displaying an interface between client computing device 204 and server computing device 202. User output 230 can alternatively or additionally include one or more speakers, transducers, or other audio outputs, a haptic interface, or other tactile feedback that provides non-visual and non-audible information to the platform user of the client computing device 204.

Although FIG. 2 illustrates the processors 210, 220 and the memories 212, 222 as being within the computing devices 202, 204, components described herein can include multiple processors and memories that can operate in different physical locations and not within the same computing device. For example, some of the instructions 214, 224, and the data 216, 226 can be stored on a removable SD card, and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operations. Computing devices 202, 204 can include one or more internal clocks providing timing information, which can be used for time measurements for operations and programs run by the computing devices 202, 204.

Server computing device 202 and client computing device 204 can be connected over the network 208 to a data center 232, which can house any number of hardware accelerators 232A-N. Data center 232 can be one of multiple data centers or other facilities in which various types of computing devices are located. Computing resources housed in the data center 232 can be specified for deploying machine learning models related to identity verification as described herein.

Server computing device 202 can be configured to receive requests to process data from client computing device 204 on computing resources in data center 232. For example, environment 200 can be part of a computing platform configured to provide a variety of services to users, through various user interfaces and/or application programming interfaces (APIs) exposing platform services. The variety of services can include verifying the credentials of the user. Client computing device 204 can transmit input data. Order verification system 218 can receive the input data, and in response, generate credential verification tokens.

Server computing device 202 can maintain a variety of machine learning models in accordance with different constraints available at data center 232. For example, server computing device 202 can maintain different families for deploying machine learning models on various types of processors and/or GPUs housed in data center 232 or otherwise available for processing.

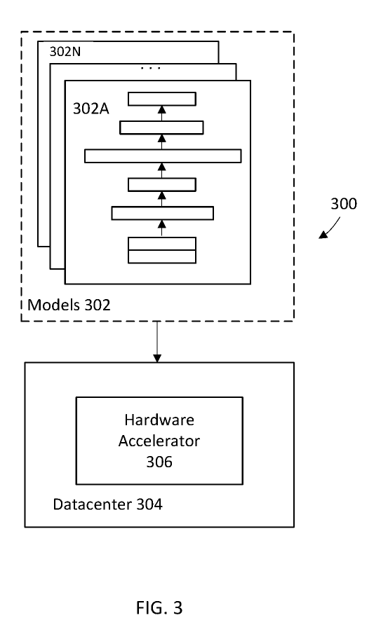

FIG. 3 depicts a block diagram 300 illustrating one or more machine learning model architectures 302, more specifically 302A-N, for each architecture, for deployment in a data center 304 housing a hardware accelerator 306 on which the deployed machine learning models 302 will execute for verifying credentials. The hardware accelerator 306 can be any type of processor, such as a CPU, GPU, FPGA, or ASIC. The hardware accelerator may refer to a specialized piece of computer hardware designed to speed up the execution of specific functions or workload, such as training machine learning models.

An architecture 302 of a machine learning model can refer to characteristics defining the model, such as characteristics of layers for the model, how the layers process input, or how the layers interact with one another. For example, the model can be a convolutional neural network (ConvNet) that includes a convolution layer that receives input data, followed by a pooling layer, followed by a fully connected layer that generates a result. The architecture 302 of the model can also define types of operations performed within each layer. For example, the architecture of a ConvNet may define that rectified linear unit (ReLU) activation functions are used in the fully connected layer of the network. One or more model architectures 302 can be generated that can output results associated with verifying the credentials.

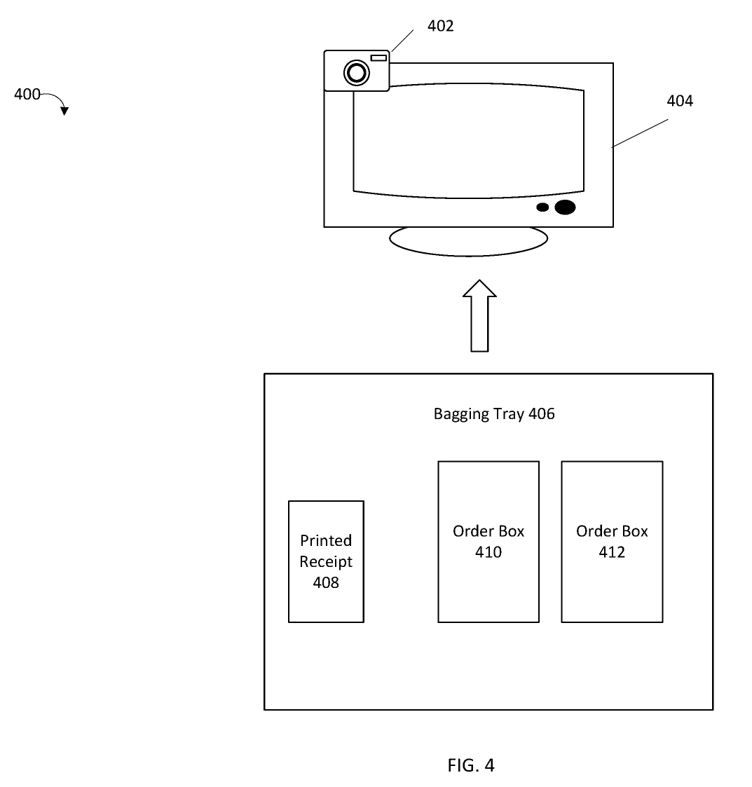

FIG. 4 depicts a block diagram illustrating an example display screen mounted on a food bagging tray. Bagging station system 400 may include bagging tray 406, where a restaurant employee places the prepared food items following printed receipt 408. Bagging station system 400 may include a display screen 404. Camera 402 may be integrated with display screen 404. According to some examples, camera 402 may be a separate component communicatively coupled to display screen 404. When the restaurant employee receives printed receipt 408, the restaurant employee places the printed receipt 408 on the bagging tray 406, such that camera device 402 may capture an image of printed receipt 408 and analyze the information included in printed receipt 408. Camera device 402 may include fixed surveillance cameras, manually triggered cameras, motion-activated cameras, weight-sensor trigger cameras, portable or modular cameras, etc. Once camera device 402 captures the image of printed receipt 408, order verification system 100 may display notifications on display screen 404. Order verification system 100 may display missing notifications on display screen 404 first, and as the restaurant employee places a food item on the bagging tray 406, the missing notification may be removed. When the restaurant employee places order box 410 and order box 412, camera device 402 may be configured to capture the image of the order boxes. Order verification system 100 may receive the captured images and verify the information from the captured images against the printer receipt 408. When the order is complete, order verification system 100 may generate and display an “order complete” notification on display screen 404.

FIG. 5A-5D depicts a diagram illustrating an example display screen. Referring to FIG. 5A, display screen 502 is shown. Display screen 502 may be equivalent to display screen 404 as depicted in FIG. 4. Display screen 502 may display an order number and multiple notifications, such as notifications 504-510. The order includes a spicy chicken sandwich, a regular chicken sandwich, a soda, and an orange juice. As none of the food items ordered are prepared and placed on the bagging tray, notification 504-510 indicates that all these food items are missing. The missing notifications may be displayed in a certain color, such as red or orange. The missing notification may also include symbols or icons representing each missing food item. Referring to FIG. 5B, a camera device, such as a camera device 402 as depicted in FIG. 4, captures an image of two cups of sodas 528, 529, and a regular chicken sandwich 512 placed on the bagging tray. As the original orders were a spicy chicken sandwich, a regular sandwich, a soda, and an orange juice, and there is a regular chicken sandwich on the bagging tray, the missing notification 508 is removed. Since the spicy chicken sandwich is not ready to be placed on the bagging tray, the missing notification 504 remains on display screen 502. Orange juice is still missing, and thus, the missing notification 510 also remains on display screen 502. Since there is an additional soda 529 placed on the bagging tray, a new notification 526 indicates that there is an extra food item on the display screen 502.

Referring to FIG. 5C, orange juice 530 is now placed on the bagging tray, and thus the missing notification 510 is removed. Extra notification 526 is removed as well since the additional soda 529 is replaced with orange juice 530. There is a new notification 532 indicating there is an extra food container. When a cheeseburger 534 packaged in a box or a container and placed on the bagging tray, notification 532 may be generated. According to some examples, the order verification system may determine the content of the food container, such as a cheeseburger, or just indicate the food in a container without specifying which food item is included inside the container. The order verification system determines that the spicy chicken sandwich is still missing, and thus, the missing notification 522 remains on display screen 502.

According to some examples, the order verification system may utilize machine learning models to determine items included in a container, on a bagging tray, etc. In one example, the machine learning models may discern spicy chicken sandwiches and regular chicken sandwiches packed in similar-looking containers or wrappers. The machine learning models may be trained to distinguish two different sandwiches based on a subtle difference or any marks, stickers placed on the outside of the containers.

Referring to FIG. 5D, as spicy chicken sandwich 536 is placed on the bagging tray and cheeseburger 534 is removed, a complete notification 538 is displayed on display screen 502. The camera device may capture the final image of the complete order and store it in the database as visual evidence that can be used in case of order disputes in the future. According to some examples, the final visual evidence may be automatically transmitted to OFO platforms before a delivery person picks up the food items for delivery. Such visual evidence may also be transmitted to the delivery driver and/or customer.

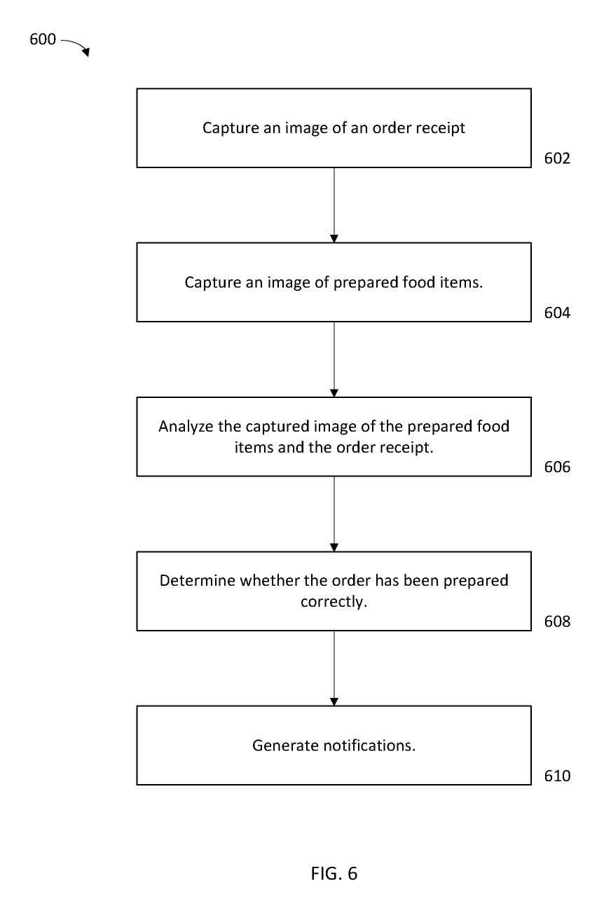

FIG. 6 depicts a flow diagram of an example process for order verification. The example process can be performed on a system of one or more processors in one or more locations, such as the order verification system 100 of FIG. 1. According to block 602, the order verification system is configured to capture an image of an order receipt. The order verification system may use a camera device to capture an image or record a video of the order receipt when the order receipt is placed on the bagging tray or any other designated location within a restaurant kitchen. The order verification system may recognize the textual information or order numbers indicated on the order receipt. In embodiments where order information is ingested electronically, such as via direct integration with a POS system or API, the step of capturing an image of the order receipt (e.g., block 602) and subsequent OCR processing steps may be bypassed or supplemented by the directly ingested electronic order data.

According to block 604, the order verification system is configured to capture an image of prepared food items. The order verification system may analyze the captured image and determine which food item has been placed on the bagging area. The same camera device described above is used to capture the image of the prepared food items. The camera device continually monitors the bagging tray and updates the images as a restaurant employee places additional food items or removes some food items from the bagging tray.

According to block 606, the order verification system is configured to analyze the captured image of the prepared food items and the order receipt. The order verification system may be configured to compare the food item captured in each image with each food item listed in the order receipt.

According to block 608, the order verification system is configured to determine whether the order has been prepared correctly. The order verification system may be configured to determine whether certain food items are still missing, additional food items are incorrectly placed on the bagging tray, or incorrect food items are placed on the bagging tray.

According to block 610, the order verification system is configured to generate notifications. Each generated notification may convey different information. For example, a missing notification may indicate which particular food item is still missing. An extra notification may indicate that the food that was not ordered by the customer was incorrectly added. Once all the correct food items are prepared and placed on the bagging tray, the complete notification may be generated, and the final visual image is captured for storage.

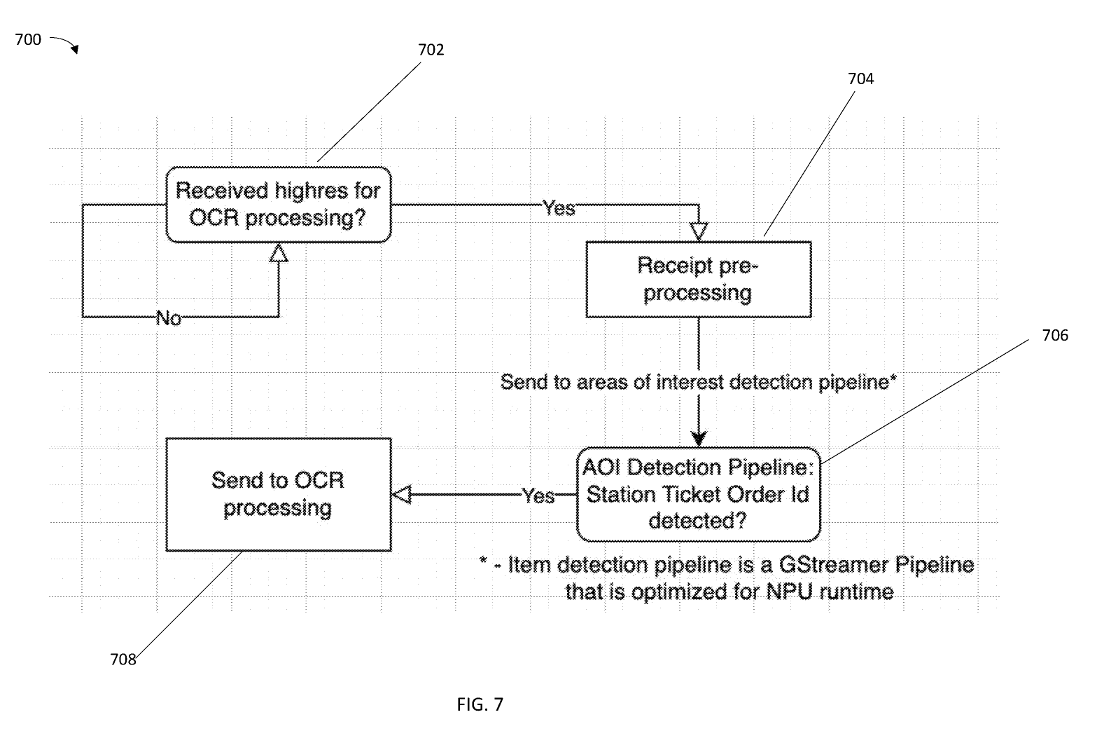

FIG. 7 depicts a flow diagram of an example order receipt ingesting process 700. The order verification system may receive an image of an order receipt captured by a camera device according to block 702. The order verification system may determine whether the captured image is a high-resolution photo image. If the order verification system determines that it is a high-resolution photo image, the process may proceed to block 704. According to block 704, the order verification system may pre-process the received image of the order receipt. The order verification system may send the received image of the order receipt to an area of interest (AOI) detection pipeline. AOI detection pipeline may be stored in memory 212 in server computing device 202 as depicted in FIG. 2.

According to block 706, the order verification system may determine whether critical information, such as a ticket order identification number, is detected. If such information is detected, the process may proceed to block 708. According to block 708, the order verification system may send the received image of the order receipt to an optical character recognition (OCR) processing.

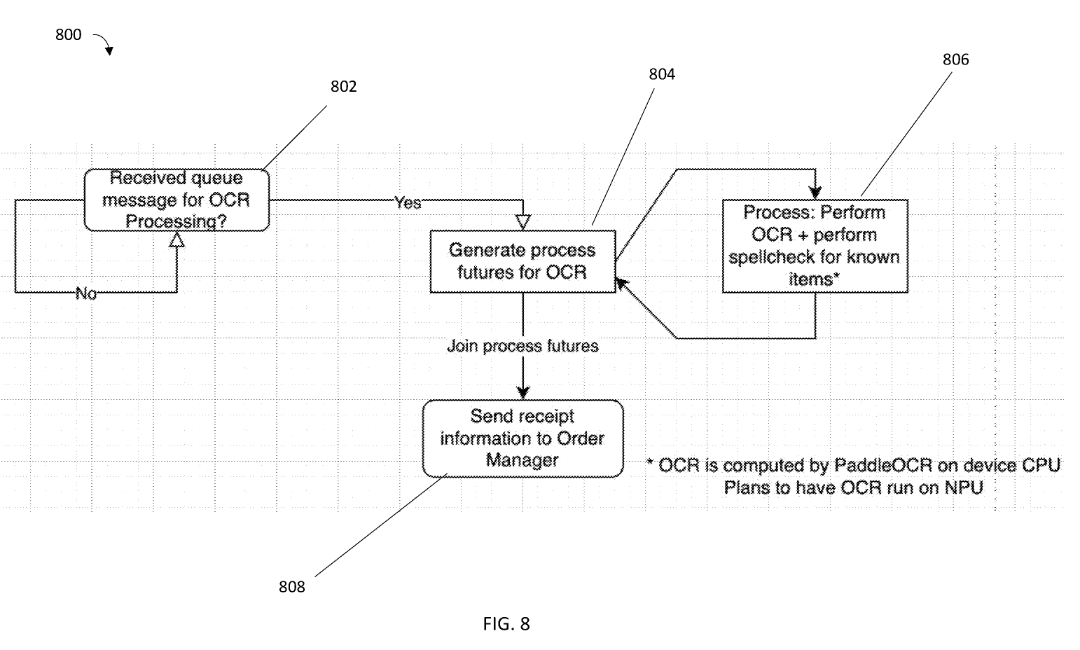

FIG. 8 depicts a flow diagram of an example order receipt analysis process 800. The order verification system may receive a queue message for OCR processing according to block 802. When the order verification system confirms the queue message for the OCR processing, the process may proceed to block 804. According to block 804, the received image of the order receipt is processed using known OCR techniques. According to block 806, the OCR process may be performed for spell checks, and known food items are recognized. Once the textual information is detected, the order verification system may send such information to special software, such as order manager software, according to block 808.

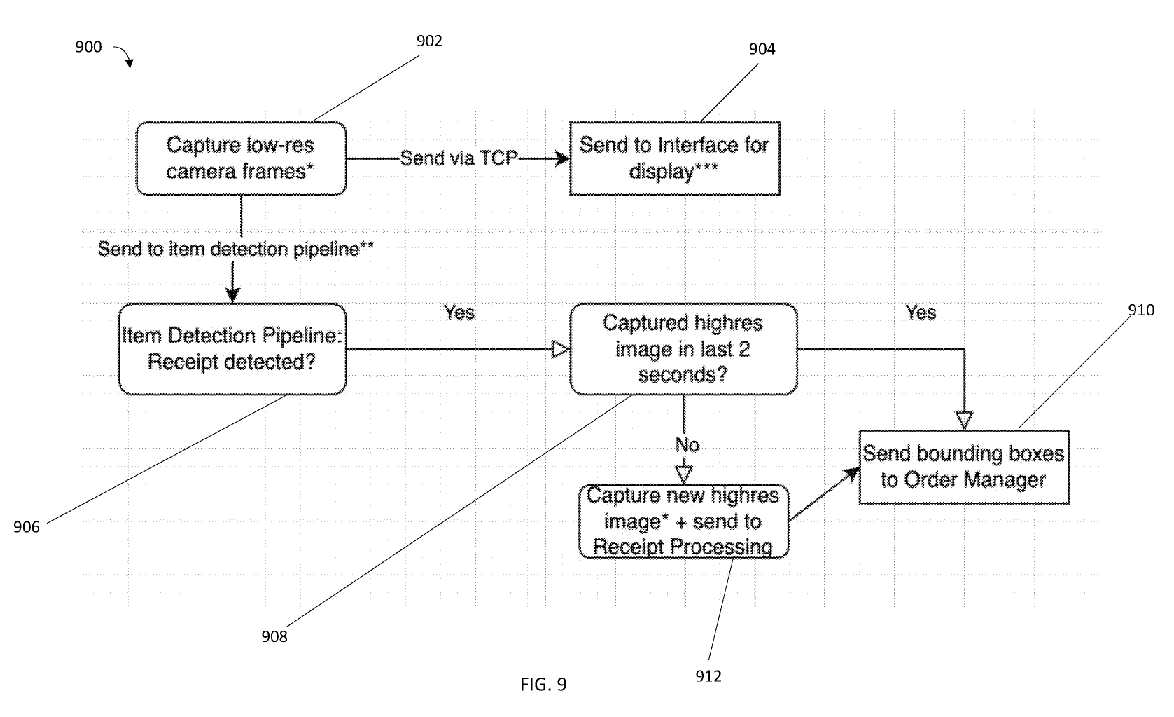

FIG. 9 depicts a flow diagram of an example image-capturing process 900. According to block 902, the order verification system may control the camera device, such as camera 402 as depicted in FIG. 4, to capture low-resolution photos of the prepared food items. The order verification system may send the low-resolution images to a display screen, such as display screen 404 as depicted in FIG. 4. The order verification system may send the capture image to the item detection pipeline stored in memory. According to block 906, the order verification system may retrieve the stored image of the order receipt. According to block 908, the order verification system may determine whether the captured image of the order receipt was captured within the last two (2) seconds. If the image was captured within the last two (2) seconds, the process may proceed to block 910. According to block 910, the order verification system may determine bounding boxes of the captured image and send them back to the order manager software. If the captured image was not taken within the last two (2) seconds, the order verification system may be configured to capture a new high-resolution image of the order receipt and re-send the newly captured image for the OCR processing.

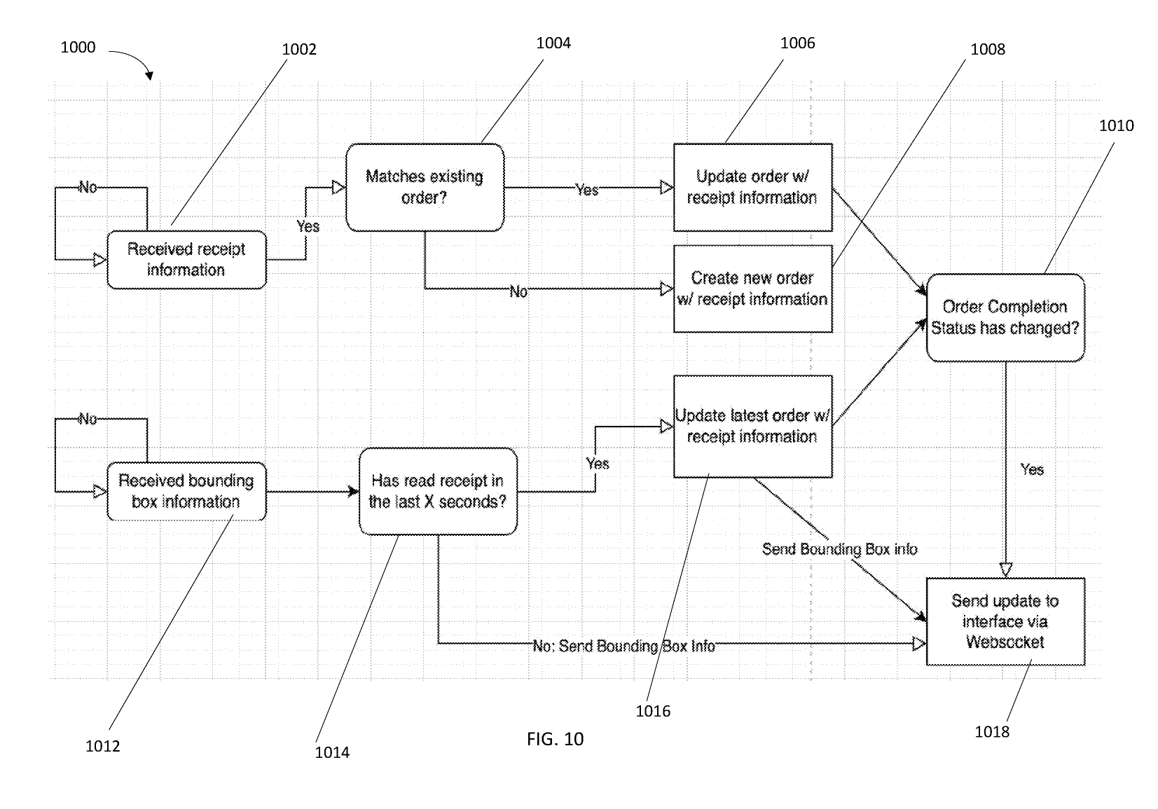

FIG. 10 depicts a flow diagram of an example process 1000 for updating order verification. According to block 1002, the order verification system may receive the captured order receipt image and the extracted order receipt information. According to block 1004, the order verification system may determine whether the matching order exists. The order verification system may determine whether the prepared food items matches the information extracted from the stored order receipt information It the order verification system finds the matching information, the order verification system may update the order with the order receipt information on display screen by overlaying the capture image of the order receipt over the currently captured images of the food items that are placed on the bagging tray. If there is no matching information, the order verification system may create a new order on the display screen with the received order receipt information according to block 1008.

According to block 1012, the order verification system may determine whether bounding box information has been received. If the bounding box information is found, the process may proceed to block 1014 to determine whether the order receipt has been read within a predefined time. If yes, the process may proceed to block 1016 to update the latest order that is being displayed on the display screen with the bounding box information. If the receipt has not been read within the predefined time, the process may proceed to block 1018. According to block 1010, the order verification system may determine whether the order has been completed. If the order verification system determines, using the captured images of the food items, whether every food item listed in the order receipt has been prepared and placed on the bagging tray. If the order verification system determines that the order is now completed, the process may proceed to block 1018 to update the notification shown on the display screen. The notification shown on the screen is updated to show that the order is now completed and ready for delivery. The latest captured image may be stored and sent to interface with a server on the OFO platform, such that the OFO platform may receive the latest captured image depicting all the ordered food items that have been successfully prepared and packaged together for delivery.

The order verification system described herein is beneficial at least in that it provides for automatic notifications indicating whether certain food items are missing without involving manual confirmation of the completeness of food preparations and packaging. The order verification system described herein may also use machine learning models trained to accurately distinguish similar food items contained in a similar wrapper. The order verification system may also be configured to automatically store the final image of complete food items and immediately send the digital image of the captured food items to the responsible OFO platforms to avoid potential order disputes, thereby reducing labor, time, and resources of the restaurants. The order verification system is also trained to generate unique sets of notifications for each unique food item under various circumstances using different colors, symbols, and icons, such that the incorrectly prepared food item can be immediately replaced with the correct food items by restaurant employees. The machine learning models can be trained to capture the images and capture the images in the format in accordance with each OFO platform's demands, such that the order verification system may be configured to automatically change its configuration of the camera device, such as angles, resolution, distance, etc. to meet the requirements of the targeted OFO platforms or specific customers.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as "such as," "including" and the like, should not be interpreted as limiting the subject matter of the claims to the specific examples; rather, the examples are intended to illustrate only one of many possible embodiments. Further, the same reference numbers in different drawings can identify the same or similar elements.

1. A method for verifying an order status, comprising:
receiving, by one or more processors, an order receipt;
capturing, by an image capturing device, one or more food items placed within a field of view of the image capturing device;
determining, by the one or more processors, whether any food items indicated in the order receipt are missing; and
automatically generating, by the one or more processors, a coded notification for display on a user interface in response to determining that one or more food items are missing from the field of view of the image-capturing device, wherein the coded notification is generated, by the one or more processors using various colors, codes, or symbols in real-time.

2. The method of claim 1, further comprising taking a snapshot or recording a video file using the image-capturing device.

3. The method of claim 1, further comprising generating the coded notification based on an output of a machine learning model.

4. The method of claim 1, further comprising utilizing a machine learning model to determine whether any food items are missing.

5. The method of claim 1, wherein the generated coded notification is dynamically updated in real time as one of the missing food items is provided within the field of view of the image capturing device.

6. The method of claim 1, further comprising generating a final notification indicating a completion of the food items indicated in the order receipt.

7. The method of claim 6, further comprising capturing a final image of the food items after the final notification is generated and transmitting the final image of the food items to a delivery party and a customer.

8. A system for verifying an order status comprising:
one or more processors; and
one or more storage devices coupled to the one or more processors and storing instructions that, when executed by the one or more processors, cause the one or more processors to:
receive an order receipt;
capture, using an image capturing device, one or more food items placed within a field of view of the image capturing device;
determine whether any food items indicated in the order receipt are missing; and
automatically generate a coded notification for display on a user interface in response to determining that one or more food items are missing from the field of view of the image capturing device, wherein the coded notification is generated using various colors, codes, or symbols in real-time.

9. The system of claim 8, wherein the one or more processors are configured to take a snapshot or record a video file using the image capturing device.

10. The system of claim 8, wherein the one or more processors are configured to generate the coded notification based on an output of a machine learning model.

11. The system of claim 8, wherein the one or more processors are configured to utilize a machine learning model to determine whether any food items are missing.

12. The system of claim 8, wherein the generated coded notification is dynamically updated in real time as one of the missing food items is provided within the field of view of the image capturing device.

13. The system of claim 8, wherein the one or more processors are configured to generate a final notification indicating a completion of the food items indicated in the order receipt.

14. The system of claim 13, wherein the one or more processors are configured to capture a final image of the food items after the final notification is generated and transmit the final image of the food items to a delivery party and a customer.

15. A non-transitory computer-readable medium for storing instructions that, when executed by one or more processors, cause the one or more processors to perform the method comprising:
receiving an order receipt;
capturing one or more food items placed within a field of view of an image-capturing device;
determining whether any food items indicated in the order receipt are missing; and
automatically generating a coded notification for display on a user interface in response to determining that one or more food items are missing from the field of view of the image-capturing device, wherein the coded notification is generated using various colors, codes, or symbols in real-time.

16. The non-transitory computer-readable medium of claim 15, wherein the method further comprises taking a snapshot or recording a video file using the image-capturing device.

17. The non-transitory computer-readable medium of claim 15, wherein the method further comprises generating the coded notification based on an output of a machine learning model.

18. The non-transitory computer-readable medium of claim 15, wherein the method further comprises utilizing a machine learning model to determine whether any food items are missing.

19. The non-transitory computer-readable medium of claim 15, wherein the method further comprises generating a final notification indicating a completion of the food items indicated in the order receipt.

20. The non-transitory computer-readable medium of claim 19, wherein the method further comprises capturing a final image of the food items after the final notification is generated, and transmitting the final image of the food items to a delivery party and a customer.
